(19) United States
(12) Patent Application Publication
(10) Pub. No.: US 2024/0157184 A1
(43) Pub. Date: May 16, 2024

(54) Flame Arrester and Methods of Manufacture

(71) Applicant: Emerson Process Management Regulator Tulsa LLC, Tulsa, OK (US)

(72) Inventor: Juan M. Diaz, Tulsa, OK (US)

(21) Appl. No.: 18/054,854

(22) Filed: Nov. 11, 2022

(51) Int. Cl. A62C 4/02

(52) U.S. Cl. CPC A62C 4/02

(57) ABSTRACT

A flame arrester is disclosed that includes one or more arrester elements each having a cell element that is configured to form a non-linear flow path through the arrester element. Cell elements can be formed from first and second strips that are wrapped together around a central core. Each of the first strip and the second strip can be configured as corrugated strips, with the first strip defining first corrugations and the second strip defining second corrugations. The first and second corrugations can be angled relative to one another to form a plurality of crossed flow paths through the cell element.

### BACKGROUND

Flame arresters can be used in a wide variety of applications to stop a flame front from propagating. In some applications, flame arresters can be installed along pipes and include one or more arrester elements having a plurality of passages configured to quench a flame to prevent the flame from travelling along the length of the pipe.

### SUMMARY

Generally, embodiments of the invention can provide improved arrangements for flame cell elements for flame arresters, which can reduce a pressure drop caused by the flame arrester (e.g., to reduce a resistance to flow) by providing a plurality of crossed or intersecting flow paths within the cell element. For example, a cell element can include two or more strips that can be rolled or stacked to form a cell element, with the strips forming alternating layers of the cell element and corresponding non-linear or otherwise tortuous flow paths. A first strip can be a first corrugated strip with a first corrugation pattern and a second strip can be a second corrugated strip with a second corrugation pattern. When arranged to form the cell element, the first and second corrugation patterns can be aligned so as to not nest with one another. For example, the corrugation patterns can be aligned so that ridges on the two strips can abut one another rather than nesting into corresponding recesses on the other strip. Thus, for example, the cell element can include a series of crossed (e.g., crossed and intersecting) flow paths within the cell element. Such crossed or intersecting flow paths can generally improve flame quenching and other capabilities of the arrester element, including with particular structural configurations and through particular flow effects as further discussed below.

According to one aspect of the disclosure, an arrester is provided for a flame arrester that defines a direction of fluid flow for operation of the flame arrester to arrest a flame propagating along a flow system. The arrester element can include a cell element that can define a central axis arranged to be substantially parallel with the direction of fluid flow when installed in the flame arrester. The cell element can include a first strip configured as a corrugated strip defining alternating first channels and first ridges, and a second strip configured as a corrugated strip defining alternating second channels and second ridges. The first and second strips can form a spiral around the central axis, with the first and the second strip forming alternating layers of the spiral. In the spiral, the first ridges can abut the second ridges to form a plurality of crossed flow paths through the cell element.

In some embodiments, along the spiral, the alternating first channels and first ridges can be at a first angle relative to the central axis and the alternating second channels and second ridges can be at a second angle relative to the central axis. The second angle can be different from the first angle. In some cases, at least one of the first angle or the second angle can be a non-zero angle relative to the central axis. In some cases, the first angle and the second angle can be approximately equal to and opposite from one another.

In some embodiments, the arrester element can further include a third strip that can be disposed between the first strip and the second strip along the spiral between the alternating layers. In some cases, the third strip can be a flat strip. In some cases, the third strip can be a corrugated strip that can define alternating third channels and third ridges, which can be at a third angle relative to the central axis along the spiral.

In some embodiments, the first ridges can abut the second ridges to form crossed and intersecting flow paths therebetween. The first strip can define a first crimp height and the second strip can define a second crimp height. Each of the first crimp height and the second crimp height can range, respectively, between approximately 0.5 millimeters and approximately 2.0 millimeters, inclusive. In some cases, the first crimp height can be approximately equal to the second crimp height. The first strip can define a first crimp width and the second strip can define a second crimp width. Each of the first crimp width and the second crimp width can range, respectively between approximately 0.7 millimeters and approximately 3.0 millimeters, inclusive. In some cases, the first crimp width can be approximately equal to the second crimp width.

According to another aspect of the disclosure, a flame arrester can be configured to be disposed along a flow conduit to arrest a flame propagating along the flow conduit. The flame arrester can include a housing having a cavity along a housing flow path and an opening for flow into the cavity. The housing can be configured to be coupled to the flow conduit so that the cavity can be in fluid communication with the flow conduit via the opening and so that fluid from the flow conduit can flow through the housing along the housing flow path. An arrester element can be disposed within the cavity along the housing flow path. The arrester element can include a cell element having a first strip and a second strip that can be spirally wrapped around a central axis. The first strip can be a first corrugated strip defining a first corrugation pattern that defines first flow channels for flow of the fluid along the housing flow path. The first flow channels can extend at a first angle relative to the central axis. The second strip can be a second corrugated strip defining a second corrugation pattern that defines second flow channels for flow of the fluid along the housing flow path. The second flow channels can extend at a second angle relative to the central axis.

In some embodiments, the first strip can abut the second strip to form a plurality of crossed and intersecting flow paths with the first and second flow channels.

In some embodiments, the cell element can further include a third strip that can be configured as flat strip. The third strip can be spirally wrapped with the first and second strips. Correspondingly, the first strip can contact the third strip to form first flow paths between the first strip and the third strip, and the second strip can contact an opposite side of the third strip from the first strip to form second flow paths between the second strip and the third strip. The first flow paths and the second flow paths can extend obliquely relative to the central axis and can include crossed and non-intersecting flow paths.

In some embodiments, the cell element can further include a fourth strip configured as flat strip. The fourth strip can be spirally wrapped around the central axis with the first, second, and third strips so that the first strip contacts the fourth strip to form third flow paths between the first strip and the fourth strip, and so that the second strip contacts the fourth strip to form fourth flow paths between the second strip and the fourth strip. The third flow paths can be parallel to the second flow paths and the fourth flow paths can be parallel to the first flow paths.

According to yet another aspect of the disclosure, an arrester element for a flame arrester can include a core defining a central axis and a cell element having a plurality layers. Each layer of the plurality of layers can include at least a first strip and a second strip that are in contact with one another to define a non-linear flow path between the first and second strips. The non-linear flow path can extend between an upstream side and a downstream side of the arrester element relative to a flame-quenching fluid flow across the arrester element.

In some embodiments, the first strip can be a corrugated strip having first corrugations at a first angle relative to the central axis and the second strip can be a corrugated strip having second corrugations at a second angle relative the central axis. The second angle can be different from the first angle. The first strip can define a first crimp height and the second strip can define a second crimp height.

In some embodiments, the first strip and the second strip can be spirally wrapped around the core so that the non-linear flow path allows a fluid flow in a substantially axial direction, relative to the central axis, from the upstream side of the cell element to the downstream side of the cell element.

According to still another aspect of the disclosure, a method of manufacturing an arrester element for a flame arrester can include wrapping a first strip and a second strip together to form a cell element around an axis that extends from a first side of the cell element to a second side of the cell element. The first strip can have first corrugations and the second strip can have second corrugations. The first and second corrugations can be configured so that, together, the first and second strips can form a plurality of crossed flow paths for flow through the cell element, between the first and second sides.

In some embodiments, the method can further include forming corrugations with a first pattern on a primary strip having a first side opposite a second side. A first portion of the primary strip can be used as the first strip and a second portion of the primary strip can be used the second strip. When wrapped together to form the cell element, the first side of the first strip can contact the first side of the second strip and the second side of the first strip can contact the second side of the second strip.

In some embodiments, the plurality of crossed flow paths formed by the first and second strips can include a plurality of intersecting flow paths within the cell element.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an isometric view of a flame arrester according to aspects of the disclosure, with a portion of a housing removed to show an arrester element therein.

FIG. 2 is a cross-sectional view of the flame arrester of FIG. 1.

FIG. 3 is a perspective view of an example corrugated strip according to aspects of the disclosure.

FIG. 4 is a front view of the corrugated strip of FIG. 3.

FIG. 5 is an isometric view of an arrester element according to aspects of the disclosure, as can be a particular example of the flame arrester element of FIG. 1.

FIG. 6 is a front view of the arrester element of FIG. 5.

FIG. 7 is a side view of the arrester element of FIG. 5.

FIG. 8 is a schematic view of a plurality of strips used to form a cell element of the arrester element of FIG. 5, shown being un-wrapped from around an axis of the arrester element.

FIG. 9 is a cross-sectional view of the arrester element of FIG. 5, taken through line IX-IX in FIG. 6.

FIG. 10 is another cross-sectional view of the arrester element of FIG. 5, taken through line X-X in FIG. 6.

FIG. 11 is another cross-sectional view of the arrester element of FIG. 5, taken through line XI-XI in FIG. 6.

FIG. 12 is a schematic exploded view of the arrester element of FIG. 5, illustrating flow paths through the cell element.

FIG. 13 is a schematic exploded view of a cell element for another arrester element according to aspects of the disclosure, illustrating flow paths through the cell element.

FIG. 14 is a schematic exploded view of a cell element for yet another arrester element according to aspects of the disclosure, illustrating flow paths through the cell element.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As used herein, unless otherwise limited or defined, “substantially parallel” indicates a direction that is within ±12 degrees of a reference direction (e.g., within ±6 degrees or ±3 degrees), inclusive. For a path that is not linear, the path can be considered to be substantially parallel to a reference direction if a straight line between end-points of the path is substantially parallel to the reference direction or a mean derivative (i.e., mean local slope) of the path within a common reference frame as the reference direction is substantially parallel to the reference direction. Additionally, as also used herein, unless otherwise limited or defined, “substantially perpendicular” indicates a direction that is within ±12 degrees of perpendicular a reference direction or structure (e.g., within ±6 degrees or ±3 degrees), inclusive. For a path that is not linear, the path can be considered to be substantially perpendicular to a reference direction if a straight line between end-points of the path is substantially perpendicular to the reference direction or a mean derivative (i.e., mean local slope) of the path within a common reference frame as the reference direction is substantially perpendicular to the reference direction. Further, as also as used herein, unless otherwise limited or defined, “substantially axial” indicates a direction that deviates radially from an axial reference path by no more than 10% of the radius of the axial reference path and a corresponding circumference relative to a central axis of the relevant element (e.g., a central axis of a core).

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items. The use of “about” or “approximately” and variations thereof herein is meant to refer to variation in the numerical quantity that may occur, for example, through the measuring of pressures or temperatures within various portions of a valve assembly that may include embodiments of the disclosure herein; through inadvertent error in these procedures; through differences in the accuracy or precision of various components used to carry out the methods; and the like. Throughout the disclosure, the terms “about” and “approximately” are intended to refer to a range of values ±10% of the numeric value that the term proceeds, inclusive.

As briefly discussed above, flame arresters can be installed along a flow conduit to prevent a flame from propagating along the conduit (e.g., in a direction of fluid flow). Some examples discussed below address flame arresters for use along flow through pipes or other similar conduits. In other examples, flame arresters can be similarly employed relative to flow through other flow conduits, including for flow paths through various process equipment or components thereof (e.g., relief valve assemblies, hose assemblies, fuel dispensing assemblies, etc.).

Flame arresters can be configured for in-line or end-of-line installations, and typically include one or more arrester elements (e.g., flame cell elements) that are disposed within a housing. Arrester elements generally include a cell element (e.g., a cell matrix) that surrounds a core (e.g., a central pin or hub) defining an axis that is oriented along the direction of fluid flow through the flame arrester. Conventional cell elements typically define a plurality of linear flow paths (e.g., micro passages) through the cell element, which are parallel with and non-intersecting with one another (e.g., are enclosed, isolated, non-crossing flow paths that extends across the cell element, between upstream and downstream sides thereof). For example, in some approaches, linear, parallel, non-intersecting flow paths are formed by wrapping a single corrugated strip and a flat (e.g., un-corrugated) strip together in repeating spiral layers around a central core. With the corrugation of the strip formed as parallel linear ridges and channels (as viewed from a selected side), each channel thus forms a distinct and non-intersecting flow path through the cell element, which is parallel to and isolated from each of the other flow paths in the cell element. The corrugations are sized to allow a fluid to flow through the resultant flow paths in the cell element while also preventing a flame from propagating across the cell element. Specifically, the material of the cell element can absorb and dissipate heat from the flame, thereby quenching the flame.

As a result of the small cross-sectional area of each flow path that is required to quench a flame, arrester elements can increase resistance to fluid flow and thereby increase pressure drop across a flame arrester. To maintain a desired fluid flow (e.g., a volumetric flow rate through the flame arrester) and to minimize pressure drop across the flame arrester, conventional flame arresters typically utilize arrester elements that are oversized relative to a connected pipe. That is, a diameter of an arrester element may be greater that the diameter of a connected pipe (e.g., twice the diameter of a connected pipe). This can increase the total number of flow paths through the flame arrester to maintain a desired flow rate corresponding to flow through the pipe. As a result of this increased size, conventional flame arresters can be bulky and heavy. Further, conventional flame arrestors can also require large amounts of material to form each arrester element, which can increase cost.

Aspects of the present disclosure provide improved configurations for arrester elements for flame arresters, which can address some or all of the issues above. In particular, arrester elements according to the present disclosure can include cell elements configured to provide non-linear, interconnected, or other generally tortuous (i.e., with many twists or bends) flow paths that can enhance flow, deflagration, detonation attenuation, or flame quenching capabilities (e.g., stopping flame propagation by absorbing heat with the cell element). Further, these types of flow paths can also reduce the overall size and material requirements of the arrester element. By reducing the size of the arrestor element, the size and cost of a corresponding flame arrestor unit can also be reduced.

For example, in some embodiments, an arrester element for a flame arrester can be formed from a plurality of strips (e.g., metal strips) that are wrapped (e.g., spirally wound or stacked to form alternating layers of strips) around a core to form a cell element. In some cases, the cell element can be secured around the core by an outer ring or other securing member (e.g., cross bars extending across the cell element, perpendicularly to an axis of the cell element). In some cases, an arrester element may not include a core or an outer ring.

Flow paths can be formed between each of the strips of a cell element to allow a fluid flow through the cell element. For example, a cell element can include a first strip and a second strip. The first strip can be a first corrugated strip having a first corrugation pattern (i.e., a first pattern of raised and recessed portions, as viewed from a selected side) and the second strip can be second corrugated strip with a second corrugation pattern (i.e., a second pattern of raised and recessed portions, as viewed from a selected side). The first and second corrugation patterns can be configured so that the first and second strips are self-supporting when layered together to form the cell element. That is, when layered to form the cell element, ridges of the first corrugations can be supported on ridges of the second corrugations (e.g., at one or more discrete points of contact) so that the first and second strips do not nest with one another. Because the first and second strips do not nest with one another, the channels between the ridges form flow paths between the strips for fluid flow through the cell element (e.g., for flow of process fluid through an arrester element). Various types of corrugation patterns can be used, for example, linear, curved, or wavy corrugation patterns. In some cases, more complex corrugation patterns can also be used, for example, V-shaped or X-shaped, or other multi-directional corrugation patterns.

Corrugation patterns on the first and second strips can be configured in some examples to provide flow paths for crossed flow through the cell element. Crossed flow occurs where flows along at least two flow paths within the cell element are not parallel to one another and are oriented so as to be aligned along a common radial direction in at least one cross-section of an axial flow. For example, relative to a particular flow section of a flame arrester, a first flow path partly defined by a first corrugation pattern can be at a non-zero angle relative to a second flow path partly defined by a second corrugation pattern. Accordingly, when projected onto a central plane of the cell element (e.g., a plane that is coincident and parallel with a central axis of the cell element), the projected flows of a crossed flow are not parallel to one another.

In some cases, fluid flow can be crossed and intersecting so that crossed flow paths intersect and combine with one another within the cell element. For example, crossed and intersecting flows can occur where fluid can flow between different flow paths defined by different corrugation patterns while flowing through the cell element (e.g., between different channels of the corrugations). In some cases, however, fluid flow can be crossed and non-intersecting so that different fluid flows along separate crossed flows paths can remain separate within the cell element. For example, crossed and non-intersecting flows can occur when two flows having different flow directions remain isolated from one another in that they remain within separate and distinct flow paths as they travel through a cell matrix (e.g., within separate channels of the corrugations). In some cases, a cell element can provide for both cross and intersecting flow, and crossed and non-intersecting flow. For example, a cell element can define a first region that provides for crossed and intersecting flow and a second region that provides for crossed and non-intersecting flow.

As one particular example, each of a first strip and a second strip can be configured as corrugated strips with first and second corrugation patterns, respectively, with corrugations on one of the strips being angled relative to corrugations on the another. For example, the first strip can define first linear corrugations having a plurality of first channels and first ridges that are oriented at a first angle relative to a central axis of the core (e.g., a direction of fluid flow) or a width axis transverse to an elongate direction of the strip. Similarly, the second strip can define second linear corrugations having a plurality of second channels and second ridges that are oriented at a second angle relative to a central axis of the core or a line transverse to an elongate direction of the strip. When appropriately aligned and spirally wrapped together, the angled relative orientation of the corrugations can provide a plurality of crossed (e.g., crossed and intersecting) flow paths.

In some examples, the first and second angles can range between 0 and 45 degrees (inclusive) in either direction (e.g., between −45 degrees and 45 degrees), relative to the central or width axis. Accordingly, the corrugations can extend at least partially in each of a circumferential and axial direction of the cell element. In some cases, one of the first angle or the second angle can be at a zero angle relative to the relevant axis, so that the respective corrugations are aligned in an axial direction. In some cases, the first angle can be symmetrically opposite the second angle (e.g., with the first angle being 20 degrees and the second angle being −20 degrees). The particular angles, and more specifically, the difference between the angles, can be selected in accordance with the flammability of the process fluid (i.e., with the type of process fluid being used), with a higher angular differences achieving high quenching capabilities. For example, for a low-flammability fluid, the difference between the first and second angles may range from approximately 10 degrees to 45 degrees, while for a comparatively high-flammability fluid the difference between the first and second angles can range from approximately 45 degrees to approximately 90 degrees.

As discussed herein, reference to an angle of certain components (e.g., structures) of a flame arrester element, relative to an axis of a spiral, can indicate an angle of the components relative to the central axis as projected onto a common reference plane. For example, for two strips that are spirally wound around a central axis, a projection plane for the strips and the central axis at a selected location along the spiral can be defined as a plane that is parallel to (e.g., the same as) one or more of: a reference plane that is parallel with the central axis and is tangent to the spiral at the selected location; or a reference plane corresponding to a flattened (i.e., unwound) configuration of the spiral at the selected location. Thus, for example, for a corrugated layer that spirals around a central axis, angles of corrugations relative to the central axis can be determined relative to either of a virtual unwrapping of the strip onto a reference plane parallel with the central axis, or a geometric projection of the central axis and the corrugations onto the same.

In general, the first angle can be different from the second angle (e.g., to differ by at least 5, 10, 15, or 20 or more degrees) so that, when the first and second strips are wrapped around the core, the strips are self-supporting on first and second ridges. That is, the first and second ridges contact one another (e.g., at discrete points), thus forming a plurality of crossed and intersecting flow paths between the first and second strips, via the first and second channels. Further, the resultant flow paths can also vary in cross sectional area (e.g., a cross-sectional area perpendicular to the axis) moving along the cell element in the direction of fluid flow.

As a result, fluid flowing through the cell element is crossed and intersecting, and can follow a number of different tortuous, non-linear paths through the cell element. For example, due to the non-linearity of these flow paths, turbulent fluid structures and other mixing flow patterns can form within the cell element, thereby enhancing flame quenching and other capabilities of the arrester element. In particular, fluid flows through the channels can be exposed to and intermingle with one another where the flow paths intersect. At the same time, because of the less direct routes for the fluid flow through the arrester, the total length of a flow path can be increased compared to conventional arrester elements for a given axial thickness of the arrester element (e.g., a distance between an upstream side and a downstream side of the arrester element). Consequently, arrester elements according to the present disclosure can provide improved flame quenching and reduced flow resistance over conventional arrester elements, allowing for smaller flame arresters to be used or to achieve better overall system performance.

In other embodiments, different strip configurations (i.e., different pluralities of strips) can also be used to form a cell element for an arrester element. For example, in some embodiments, an arrester element can include a cell element that is formed from three strips that surround (e.g., are wrapped together around) a central core to form repeating layers of each strip around the core. The first and second strips can be corrugated strips configured similarly to those described above and the third strip can be a flat strip that is disposed between the first and second strips (e.g., when arranged in a flattened, non-wound configuration). Accordingly, when surrounding (e.g., wrapped around) the core, a first side of the third strip contacts ridges along a first side of the first strip, forming a first plurality of linear flow paths between the first strip and the third strip. Similarly, a second side of the third strip contacts ridges along a first side of the second strip, forming a second plurality of linear flow paths between the second strip and the third strip. The first and second pluralities of flow paths can be angled relative to one another so that they are crossed and non-intersecting. Further, as similarly described above, a second side of the first strip can contact a second side of the second strip (e.g., at discrete contact points between the respective ridges), to form a third plurality of crossed and intersecting flow paths between the first and second strips.

In some embodiments, a cell element for an arrester element can further include a fourth strip that can be configured as a second flat strip that surrounds (e.g., wraps around) the core with the other strips (e.g., the first, second, and third strips). The fourth strip can be arranged so that the second strip is between the third strip and the fourth strip (e.g., with the strips in a flattened, non-wound configuration). Accordingly, when surrounding (e.g., wrapped around the core) the first and second corrugated strips are separated from one another by the fourth strip. Consequently, rather than forming a plurality of interconnected flow paths, a first side of the fourth strip contacts ridges along the second side of the first strip to form a third plurality of linear flow paths between the first strip and the fourth strip, and a second side of the fourth strip contacts ridges along the second side of the of the second strip to form a fourth plurality of linear flow paths between the first strip and the fourth strip. The third plurality of flow paths can be parallel to the first plurality of flow paths and the fourth plurality of flow paths can be parallel to the second plurality of flow paths. As a result, flow in the cell element is cross and non-intersecting so that flow from the individual flow paths does not mix within the cell element itself, but can collapse one another upon exiting the cell element. Correspondingly such an arrangement may be particularly useful where multiple arrester elements are used in a single flame arrester so that the flow exiting one arrester element collapse on each other prior to entering a subsequent arrester element.

Some examples of the disclosed technology can also provide a method of manufacturing an arrester element for a flame arrester. In particular, the method can include wrapping (e.g., spirally wrapping) a plurality of strips together (e.g., simultaneously) around a central core to form a spiral-shaped cell element. The plurality of strips can include at least two corrugated strips arranged as described above to provide flow paths with different flow directions within the same cell element. In particular, the corrugated strips can be arranged next to one another to form a plurality of tortuous flow paths therebetween. In some cases, the first and second strips can be formed from corresponding portions of a primary strip (e.g., by cutting a single primary strip into the first and second strips or making two separate primary strips). The primary strip defines a first side opposite a second side. Correspondingly, the first strip and second strip can be oriented symmetrically opposite one another, so the first side of the first strip contacts the first side of the second strip, and vice versa, to form a crossed and intersecting flow path between the strips.

The principles of the present disclosure are applicable to various types of flame arrester, deflagration, and detonation attenuation systems, including those configured for in-line applications (e.g., to be coupled at an intermediate position along a length of pipe) or for end-of-line applications (e.g., to be coupled to an end of a pipe).

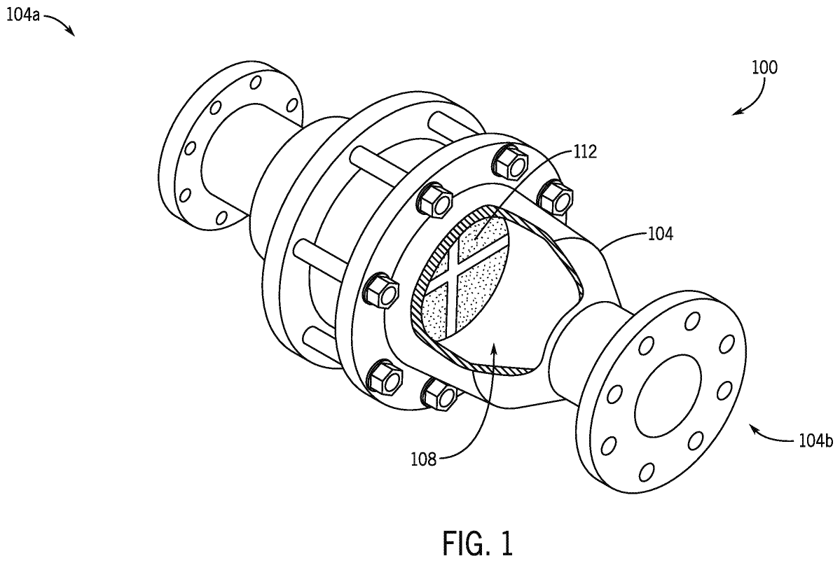

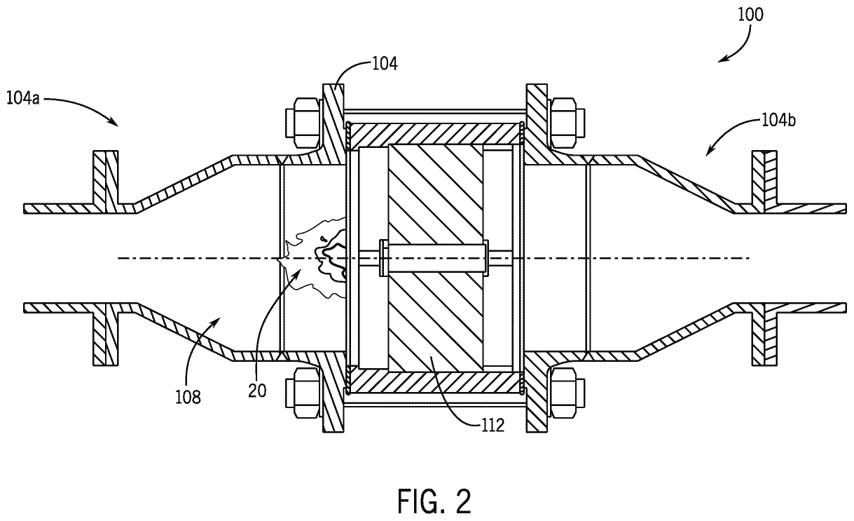

Referring now to FIGS. 1 and 2, an example flame arrester 100 is illustrated. The flame arrester 100 is configured as an in-line flame arrester, however, the principles discussed herein are not limited to this particular configuration and can be applied to other types of flame arresters and similar systems, as noted above. As illustrated, the flame arrester 100 generally includes a housing 104 that is configured to couple at each end to a pipe 102. The housing 104 defines an internal cavity 108 that can be fluidly coupled to the pipe 102 at each of a first end 104a (e.g., an upstream end) and a second end 104b to allow a fluid to flow through the pipe 102, via the flame arrester 100.

As mentioned above, one or more arrester elements can be disposed within a housing (e.g., within an internal cavity of the housing) to prevent a flame from propagating through the flame arrester, while still allowing fluid to flow through the pipe 102. For example, the flame arrester 100 includes an arrester element 112 disposed within the cavity 108. The arrester element 112 is configured as a disc-shaped arrester element that is oriented with central axis 114 that is substantially parallel to direction of fluid flow through the arrestor element 112 (e.g., to extend from the first end 104a to the second end 104b). As will be discussed in greater detail below, the arrester element 112 can define a plurality of flow paths that are configured to allow fluid to flow through the flame arrester while also being able to quench a flame 20 that is propagating along the pipe 102 (e.g., along a fluid flow to move in a direction from the first end 104a to the second end 104b). Correspondingly, the first end 104a can be an unprotected end (e.g., where a flame can be present) and the second end can be a protected end (e.g., where a flame cannot occur due to quenching by the arrester element 112), or vice versa. In some embodiments, the flame arrester 100 can also include a shock-absorbing element (not shown) at an unprotected end (e.g., the first end 104a or the second end 104b), to protect the arrester element 112 from a pressure wave produced by a flame front. Example shock-absorbing elements can include an orifice plate, a protruding tube, or another type of shock-absorbing element.

Continuing, individual flow paths can be sized (e.g., with a particular axial length and cross sectional area taken perpendicular to the axial length) to quench the flame as it passes through the arrester element 112 from the first end 104a (e.g., an unprotected side), thereby preventing the flame from reaching the second end 104b (e.g., a protected side) of the flame arrester 100 and continuing along the pipe 102. The size of the flow paths, and thus the quenching capability of the arrester element 112, can be a function of the type of fluid and the specific operating conditions. In general, longer passages with smaller cross sectional areas (e.g., smaller individual flow paths) can improve quenching capabilities. With conventional systems, longer flow paths are typically formed by increasing a thickness of an arrester element (e.g., a distance between an unprotected side and a protected side and second end of an arrester element taken along a direction of fluid flow). Correspondingly, flow paths with smaller cross sectional areas are typically formed by reducing a size of the corrugations of a corrugated strip.

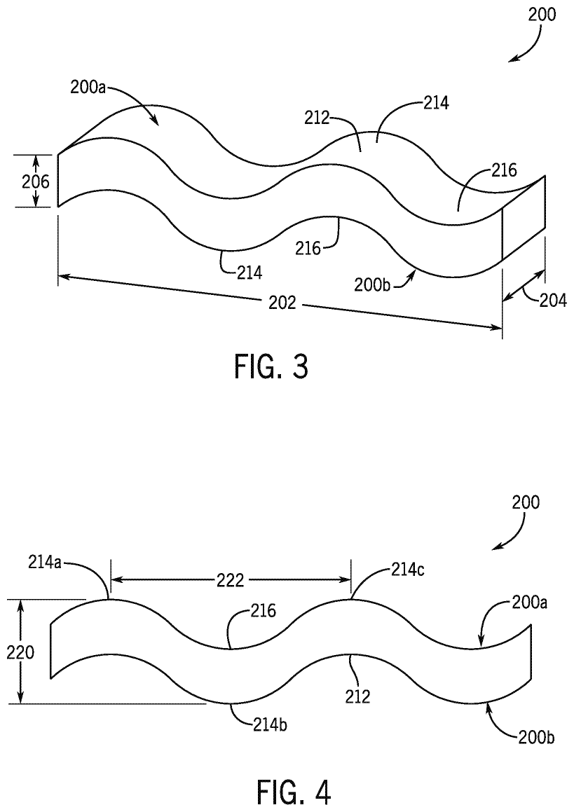

Referring to FIGS. 3 and 4, a corrugated strip 200 generally defines a length 202 (e.g., a longest dimension), a width 204 that is perpendicular to the length 202, and a thickness 206 that is perpendicular to both the length 202 and width 204. The corrugated strip 200 includes corrugations 212 configured as a plurality of alternating and substantially parallel ridges 214 and channels 216; although other, more complex configurations are possible (e.g., as with V-shaped or X-shaped corrugations). As illustrated, the corrugations 212 are configured as smooth, wavy corrugations. In other embodiments, other shapes of corrugations can also be used, for example, triangular or square shaped corrugations.

The ridges 214 and channels 216 are present on both a first side 200a and an opposing second side 200b of the corrugated strip 200, with a ridge 214 on one side corresponding to a channel 216 on the opposite side, and vice versa (e.g., so that a pattern on one side of a strip appears as a mirror image on a second, opposing side of the strip). The corrugations 212 define a height 220 (e.g., a crimp height) taken between the peaks of a ridge 214a on the first side 200a and a peak of an adjacent ridge 214b on the second side 200b (e.g., a peak of a ridge 214 that corresponds with an adjacent channel 216 on the first side 200a). In some cases, a crimp height can range between about 0.15 millimeters and about 2.0 millimeters (inclusive), or more specifically, about 0.38 millimeters, about 0.45 millimeters, about 0.5 millimeters, about 0.60 millimeters, about 0.74 millimeters, about 0.80 millimeters, about 1.14 millimeters, about 1.16 millimeters, about 1.5 millimeters, or about 1.75 millimeters, or any ranges therebetween (e.g., between about 0.5 millimeters and about 2.0 millimeters). Still, in some cases, other crimp heights may be used depending on the specific operational parameters, for example, a desired quenching capability, flow rate, or type of process fluid, and may be less than about 0.15 millimeters or greater than about 2.0 millimeters.

In addition, the corrugations 212 define a width 222 (e.g., a crimp width) between the peaks of adjacent ridges 214 on the same side (e.g., ridge 214a and ridge 214c), taken perpendicular to the corrugations 212 (e.g., an extension direction of the corrugations). While the corrugations 212 are illustrated as extending substantially parallel to the width 204, corrugations can be oriented differently in other embodiments. The size of the corrugations 212, and thus the size of flow paths, can be made smaller by reducing the height 220 or width 222 of the corrugations 212. In some cases, a crimp width can range between about 0.3 millimeters and about 3.8 millimeters (inclusive), or more specifically, about 0.7 millimeters, about 0.75 millimeters, about 0.9 millimeters, about 1.2 millimeters, about 1.6 millimeters, about 2.3 millimeters, about 2.6 millimeters, about 3 millimeters, about 3.5 millimeters, about 3.75 millimeters, or any ranges therebetween (e.g., between about 0.7 millimeters and about 3 millimeters). Still, in some cases, other crimp widths may be used depending on the specific operational parameters, for example, a desired quenching capability or type of process fluid, and may be less than about 0.3 millimeters or greater than about 3.8 millimeters.

In some cases, crimp height may have a larger effect on quenching capability than crimp width. For example, depending on the specific operation parameters, two arrestor elements with similar crimp heights but different crimp widths may be able to achieve similar quenching capabilities. Correspondingly, it is possible to have a crimp width that is equal to or greater than a crimp height without significantly reducing quenching capability.

In some embodiments, corrugations can also be made smaller by decreasing the thickness 206 of the strip 200. For example, strips can have a thickness 206 between 0.002 inches and 0.008 inches, which can allow the strip 200 to be more easily bent to form the corrugations 212 (e.g., by feeding a flat strip through toothed rollers that are configured to crimp or otherwise bend the flat strip to form the corrugations 212). In other embodiments, other methods for forming corrugations can also be used. Further, by reducing a thickness of the strip, the ratio of the cross sectional area of cell element that is open to flow (e.g., the cumulative cross-sectional area of the individual flow paths) to the cross sectional area that is blocked by the strips can be increased.

However, in some cases, reducing the size of the individual paths can increase flow resistance through an arrester element. This increase in flow resistance can result in an increased pressure drop across an arrester element. As also discussed above, to counter the increased resistance to flow, some conventional flame arresters can utilize oversized arrester elements (e.g., with an overall cross sectional area that is larger than a corresponding cross sectional area of a connected pipe) to increase the total number of flow paths and thereby increase a total available flow area. Additionally, some conventional flame arresters can utilize multiple arrester elements with larger flow paths, which can be arranged in series so that the flame would have to pass through multiple arresters to reach a protected side of the flame arrester. In both cases, this can result in more complex and higher-cost flame arresters.

Some flame arresters according to the disclosure can utilize one or more arrester elements that are configured to provide a crossed flow through the arrester element. In some cases, the crossed flow path, and in particular, a crossed and intersecting flow path, can allow for flow paths with larger effective cross sectional areas (e.g., an average cross sectional area), or can provide non-linear, relatively convoluted, fluid flow paths within the arrester element. Alone or collectively, these improvements can enhance quenching capabilities for a given size of an arrester by effectively increasing the length of the flow paths, without having to increase a thickness of an arrester (i.e., as measured along a main flow direction of the quenching assembly). As a result, similar quenching capabilities, as compared with conventional systems, can be achieved with smaller arrester elements and with reduced flow resistance through the arrester elements.

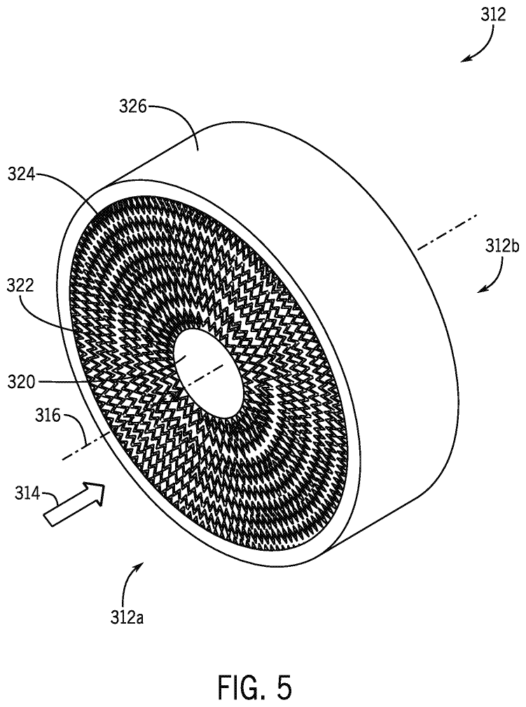

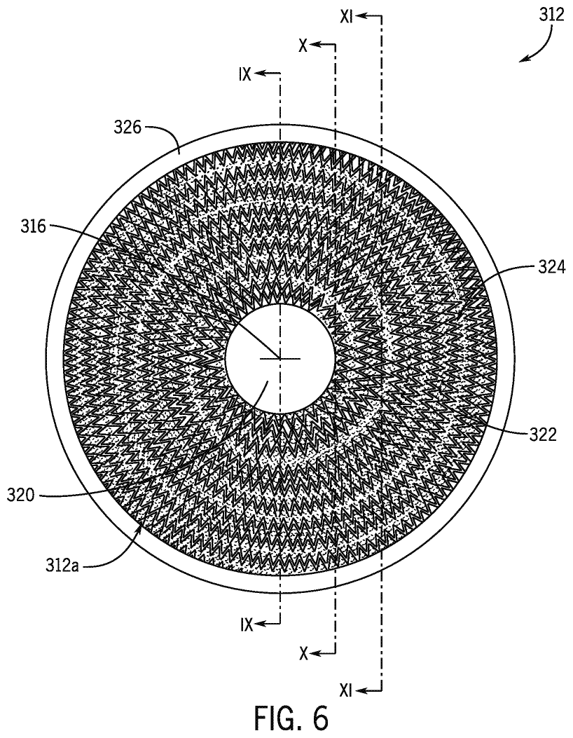

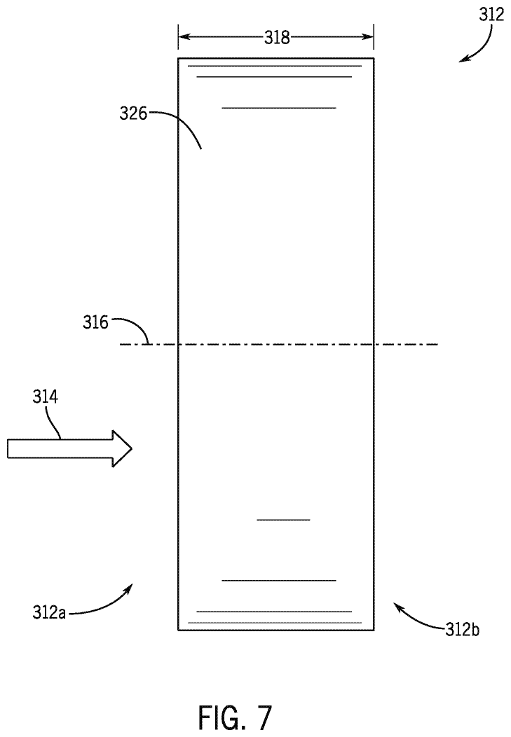

For example, referring now to FIGS. 5-7, an arrester element 312 (e.g., an arrester element for use with the flame arrester 100) can be configured to provide a plurality of crossed flow paths (e.g., tortuous flow paths) to allow fluid to flow from a first side 312a of the arrester element 312 to a second side 312b of the arrester element 312, as indicated by the arrow 314. As illustrated, the arrester element 312 is configured as a disc-shaped arrester element defining a central axis 316 and having a thickness 318 (see FIG. 7) taken along the axis 316. While the central axis 316 is shown being substantially parallel with the fluid flow 314 through the arrester element 312 (e.g., a cell element thereof), in other embodiments, the axis 316 can be angled (e.g., substantially perpendicularly) to the fluid flow through the arrester element 312 (e.g., to allow for radial flow).

The arrester element 312 generally includes a core 320 (i.e., a center pin) and a cell element 322 surrounding the core 320. The core 320 defines a central axis (e.g., the central axis 316 of the cell element 322 and the arrester element 312) that can be substantially parallel to a direction of fluid flow through the arrester element 312. Correspondingly, the cell element 322 can define a plurality of flow paths 324 to allow fluid to flow through the arrester element 312 (e.g., in a substantially axial direction relative to the axis 316). In some embodiments, the arrester element 312 can include a securing structure to aid in securing the cell element 322 to the core 320 and to facilitate installation of the arrester element 312 in a housing of a flame arrester. Here, the securing structure is configured as an outer ring 326 that surrounds the cell element 322. In some embodiments, a core may not be provided and the cell element 322 can define the central axis 316 of the arrester element 312.

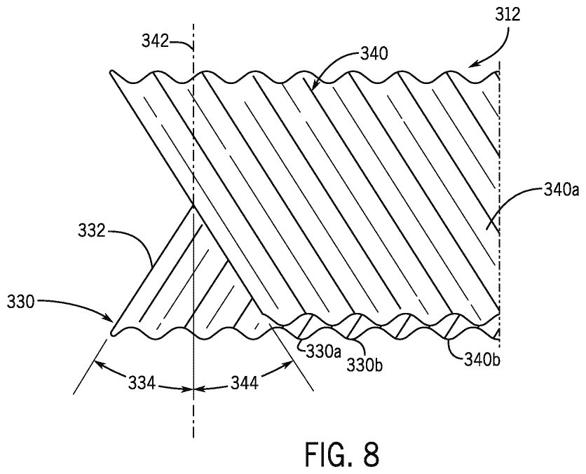

In some embodiments, a cell element can be formed by (simultaneously) wrapping a plurality of strips in spiral shape. That is, the plurality of strips can be spirally wrapped together about a central axis to form a plurality of repeating layers of the plurality of strips moving in a radial direction away from the central axis. For example, turning now to FIGS. 8-10, the cell element 322 can be formed by spirally wrapping a first strip 330 and a second strip 340 around the core 320 to form a spiral about the axis 316 (e.g., two meshed spirals corresponding to each of the first strip 330 and the second strip 340). In other embodiments, concentric rings of strips can be arranged in repeating layers (e.g., in a radial or axial direction) about a central axis instead of spirally wrapping the strips together about an axis. When wrapped around the core 320, the first and second strips 330, 340 can define the flow paths 324 (e.g., crossed and intersecting flow paths) between directly adjacent portions of the first and second strips 330, 340.

In the illustrated embodiment, the first and second strips 330, 340 are configured as corrugated strips having corrugations 332, 342, respectively. The corrugations 332, 342 are configured as linear corrugations that are angled relative to one another, and which are oblique to the central axis 316 (e.g., to form a helical shape when wrapped about the central axis 316). In particular, FIG. 8 shows a portion of the first and second strips 330, 340 un-wrapped relative to the axis 316. Thus, as collectively unwrapped or equivalently projected onto a common plane of the page of FIG. 8, which can be, for example, oriented parallel to the axis 316 or tangent to either of the relevant strips at a projection of the axis 316 onto the plane, the first corrugations 332 can extend at a first angle 334 that opens in a first direction relative to the axis 316 (e.g., anti-clockwise in the wrapped spiral). Similarly, the second corrugations 342 can extend at a second angle 344 that opens in a second direction relative to the axis 316 (e.g., clockwise in the wrapped spiral). (Although the simplified view of FIG. 8 shows the angles 334, 344 with reference to extended profiles of the peaks of the relevant corrugations, the angles 334, 344 can be measured in particular at a projected intersection between the axis 316 and the corrugation or other relevant feature. Thus, for example, similar angles are also shown at the center of the cross-sections of FIGS. 10 and 11, in alignment with a projection of the axis 316.)

Each of the first angle 334 and the second angle 344 can range between approximately 0 degrees and 45 degrees in each direction (i.e., between −45 degrees and +45 degrees), relative to the axis 316 (e.g., a direction of fluid flow through the cell element 322). However, the first angle 334 is generally different from (i.e., not approximately equal to) the second angle 344 (e.g., in direction, as shown, or in absolute magnitude) so that the first and second strips 330, 340 are mutually self-supporting on their respective ridges (see e.g., ridge 214 in FIGS. 3 and 4). As a result, the first and second strips 330, 340 do not nest with one another. Rather, the distal (peak) portions of the ridges of the corrugations 332 abut the distal (peak) portions of the ridges of the corrugations 342, so that neither set of ridges closes a corresponding opposing channel. Thus, as further discussed above and below, the misaligned configuration of the corrugations 332, 342 can form crossed and intersecting flow paths 324 therebetween, via the corresponding channels.

In particular, an angle of separation between the first angle 334 and the second angle (i.e., the absolute value of the difference between the first angle 334 and the second angle 334) can be at least 10, 20, or 30, inclusive, or can be more than 30 degrees. As illustrated, each of the first angle 334 and the second angle are non-zero angles, with the first angle 334 being approximately 30 degrees relative to the central axis 316 and the second angle being approximately −30 degrees relative to the central axis 316 (e.g., to be symmetrically opposite the first angle 334). Accordingly, the angle of separation is approximately 60 degrees. In other embodiments, the first and second angle 334, 344 can be different. For example, the first angle 334 can be approximately 0 degrees and the second angle 344, can be greater or less than 0 degrees (i.e., a non-zero angle). The particular angle of separation can depend on the specific configuration of the corrugations or other operational parameters, but can generally be selected to prevent nesting of the strips being used. For example, an angle of separation can be selected so that each ridge on a first strip contacts at least two other ridges on a second strip. In some cases, greater separation angles, can improve flame quenching by increasing cross-flow, but may also increase flow resistance if the separation angle becomes too large. Correspondingly, it can be preferable that a separation angle is between 90 degrees and 10 degrees, or any range therebetween (e.g., between 80 degrees and 20 degrees, 60 degrees and 30 degrees, 50 degrees and 40 degrees).

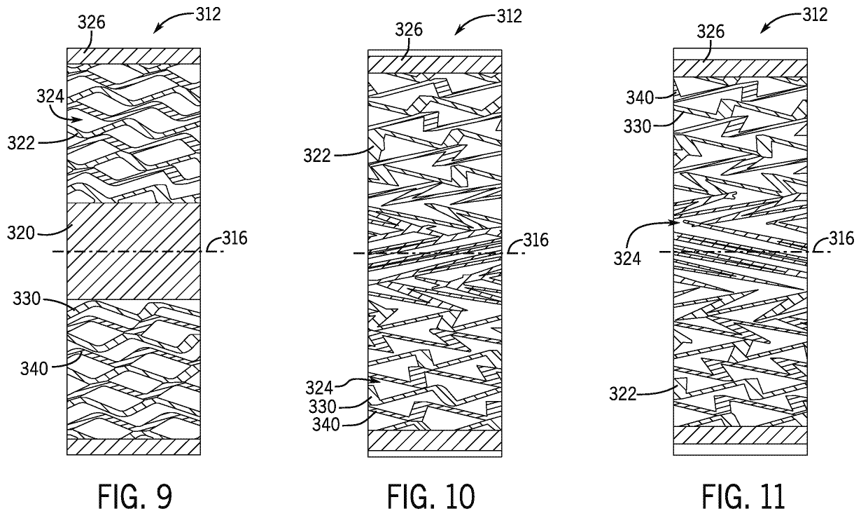

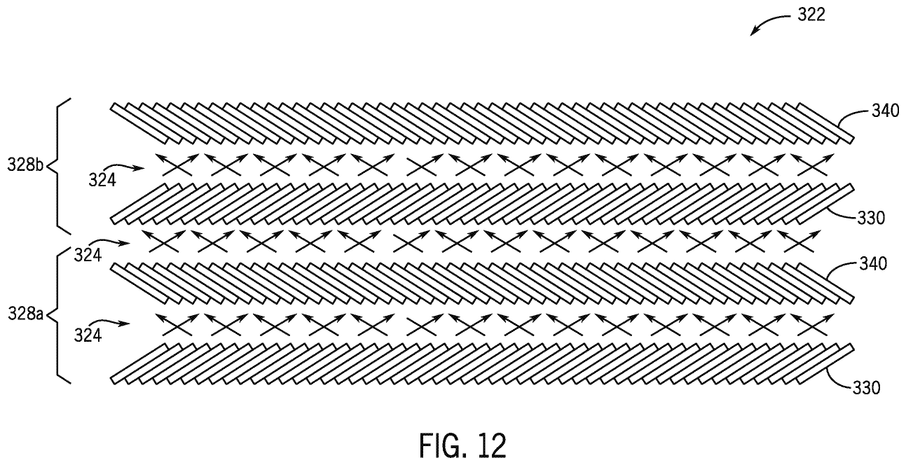

In that regard, due to the angle of separation between the respective corrugations 332, 342, first and second strips 330, 340 contact at discrete points along the lengths of the corresponding ridges. Correspondingly, portions of the channels of one strip will be aligned with portions of the ridges of the other strip. As a result, referring to FIGS. 9-12, fluid flowing through the cell element 322 can flow across ridges and between different channels to form crisscrossing (i.e., crossed and intersecting) and irregularly-shaped flow paths 324 (e.g., with a variable cross sectional area) through the cell element 322. Specifically, crossed and intersecting flow paths are formed between the strips in each wrap of the strips 330, 340 (e.g., in each of a first wrap 328a and a second wrap 328b), as well as between the wraps (e.g., between the first and second wraps 328a, 328b). This can allow fluid flows to collide and collapse onto each other within the cell element 322. The colliding flows can result in eddy currents or other non-linear flow patterns forming in the flow paths 324, which can improve quenching as compared to similar sized flow paths in conventional designs. Correspondingly, larger flow paths can be provided to reduce flow resistance or the arrester element can be made smaller (e.g., to reduce a diameter or thickness thereof), all while maintaining the quenching capability similar to the comparative conventional design.

Where a first strip and a second strip have opposite and approximately equal corrugation angles (e.g., with a first strip having a corrugation angle of approximately 20 degrees and a second strip having a corrugation angle of approximately −20 degrees, so that the magnitude of each corrugation angle is approximately equal), the first and second strip can be formed using portions of a primary strip (e.g., a single strip that is cut into two, or two strips that are identical to one another in at least one orientation). For example, the first strip 330 and the second strip 340 can be formed from portions of a primary strip having a first side opposite a second side (see e.g., corrugated strip 200). Accordingly, the first strip 330 defines a first side 330a and a second side 330b, which correspond with a first side 340a and a second side 340b of the second strip 340. Thus, to form the crossed and intersecting flow paths 324, one of the first strip 330 or the second strip 340 is flipped prior to being wrapped together to form the cell element 322. As a result, the first side 330a of the first strip 330 contacts the first side 340a of the second strip 340, and the second side 330b of the first strip 330 contacts the second side 340b of the second strip 340.

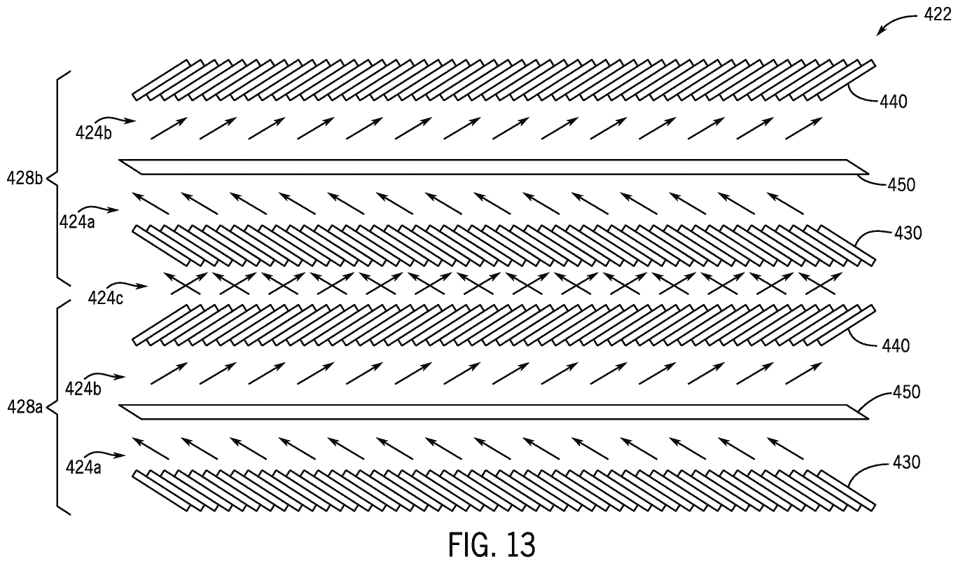

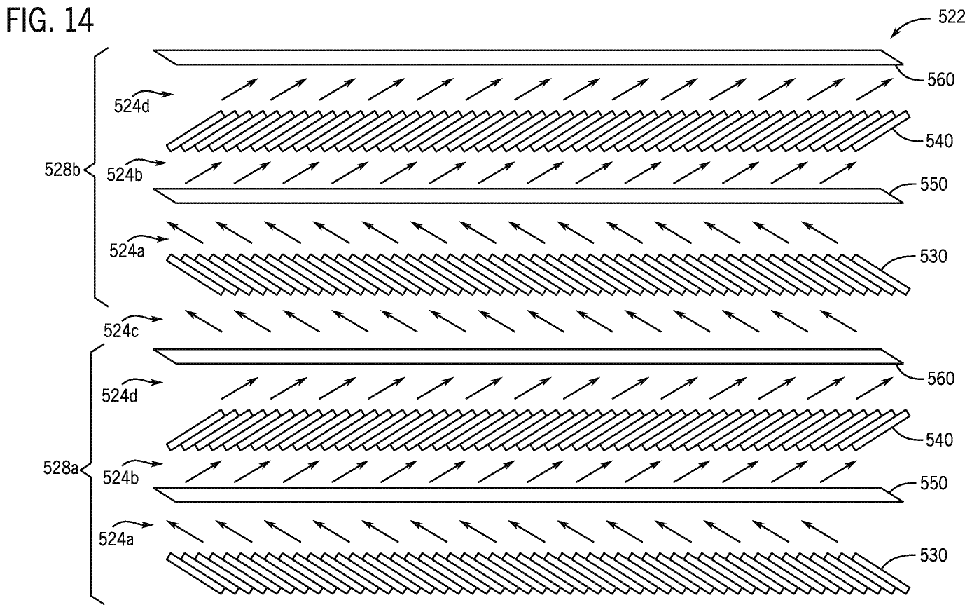

In some embodiments, a plurality of strips used to form a cell element can be configured differently to provide different flow regimes within the cell element (e.g., to provide both crossed and intersecting, and crossed and non-intersecting flows). For example, FIG. 13 illustrates another embodiment of a cell element 422 that can be configured generally similarly to the cell element 322, but which include three strips. Specifically, each wrap of the strips (e.g., first wrap 428a and second wrap 428b) includes a first strip 430 (e.g., a first corrugated strip that is similar to the corrugated strip 330), a second strip 440 (e.g., a second corrugated strip that is similar to the corrugated strip 340), and a third strip 450 (e.g., a first flat strip with no corrugations) disposed between the first strip 430 and the second strip 440 (e.g., in a radial direction). Within each wrap 428a, 428b, the first strip 430 contacts the third strip 450 to form first linear flow paths 424a in a first direction and the second strip 440 contact an opposing side of the third strip 450 to form second linear flow paths 424b in a second direction that is different from the first direction. The first and second flow paths 424a, 424b, are angled relative to a central axis 416 in accordance with the angles of the corrugations (e.g., channels of the corrugations) from which they are formed. Accordingly, the first flow paths 424a and the second flow paths 424b form crossed and non-intersecting flow paths, each of which are isolated from the other flow paths. Further, between each wrap 428a, 428b, the first and second strips 430, 440 form third, crossed and intersecting flow paths 424c, similar to the first and second strips 330, 340 described above. Thus, the cell element 422 can provide both linear flow regimes (e.g., the crossed and non-intersecting flows) and non-linear flow regimes (e.g., the crossed and intersecting flows) within the cell element.

As another example, FIG. 14 illustrates yet another embodiment of a cell element 522 that can be generally similarly configured to the cell elements 322, 422 but which include four strips. Specifically, each wrap of the strips (e.g., first wrap 528a and second wrap 528b) includes a first strip 530 (e.g., a first corrugated strip), a second strip 540 (e.g., a second corrugated strip), and a third strip 550 (e.g., a first flat strip), configured and arranged similarly to the first, second, and third strips 430, 440, 450, respectively. In addition, each wrap further includes a fourth strip 560 (e.g., a second flat strip), which is arranged so that the second strip 540 is between the third strip 550 and the fourth strip 560 (e.g., in a radial direction). Put another way the fourth strip 560 is arranged between the second strip 550 of the first wrap 528a and the first strip of the second wrap 528b.

Correspondingly, first linear flow paths 524a can be formed between the first strip 530 and the third strip 550, second flow paths can be formed between the second strip 540 and the third strip 550, third linear flow paths 524c can be formed between the first strip 530 and the fourth strip 560 (e.g., between the wraps 528a, 528b), and fourth flow paths 424d can be formed between the second strip 540 and the fourth strip 560. The first linear flow paths 524a are parallel to the third linear flow paths 524c and second linear flow paths 524b are parallel to the fourth linear flow paths 524d. Likewise, the first and fourth linear flow paths 524a, 524d are angled differently from the second and third linear flow paths 524b, 524c.

Because the flow paths 524 (e.g., the first, second, third, and fourth flow paths 524a-d) are all linear in nature, fluid flows therein remain separate and do not mix, resulting in crossed and non-intersecting flow paths. However, due to the different directionalities of the flows (e.g., to produce counter-rotating flows upon exit from the cell element 522), the individual flows from each of the pluralities of flow paths 524 can collapse on one another after exiting from the cell element 522. Accordingly, the cell element 522 may be particularly useful in applications where a flame arrester is provided with multiple arrester elements by allowing the flows to collapse on one another after exiting one arrester element and prior to entering a subsequent arrester element.

Further, and although the flow paths 524 are substantially linear, the angled nature of the flow paths 524 increases an effective length of each flow path 524 without increasing a thickness of the cell element (e.g., a thickness of an arrester element.). This can increase quenching capabilities as compared to conventional cell elements with only axially aligned flow paths. Moreover, because multiple strips can be wound together simultaneously a cell element can be wound to a desired external diameter with a fewer number of wraps, thus decreasing cycle time in manufacturing.

Thus, embodiments of the disclosed technology can provide improved flame arrester arrangements, in particular, arrangements for cell elements, that provide enhanced quenching and flow characteristics. The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “only one of,” or “exactly one of.” For example, a list of “only one of A, B, or C” indicates options of: A, but not B and C; B, but not A and C; and C, but not A and B. A list preceded by “one or more” (and variations thereon, e.g., “at least one of”) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

We claim:

1. An arrester element for a flame arrester, the flame arrester defining a direction of fluid flow for operation of the flame arrester to arrest a flame propagating along a flow system, the arrester element including:
a cell element defining a central axis arranged to be substantially parallel with the direction of fluid flow when the cell element is installed in the flame arrester, the cell element including:
a first strip configured as a corrugated strip defining alternating first channels and first ridges, and
a second strip configured as a corrugated strip defining alternating second channels and second ridges,
the first and second strips forming a spiral around the central axis, with the first and the second strip forming alternating layers of the spiral, in which the first ridges abut the second ridges to form a plurality of crossed flow paths through the cell element.

2. The arrestor element of claim 1, wherein along the spiral the alternating first channels and first ridges are at a first angle relative to the central axis and the alternating second channels and second ridges are at a second angle relative to the central axis, the second angle being different from the first angle.

3. The arrester element of claim 2, wherein at least one of the first angle or the second angle is a non-zero angle relative to the central axis.

4. The arrester element of claim 3, wherein the first angle and the second angle are approximately equal to and opposite from one another.

5. The arrester element of claim 1, further comprising a third strip that is disposed between the first strip and the second strip along the spiral between the alternating layers.

6. The arrester element of claim 5, wherein the third strip is a flat strip.

7. The arrester element of claim 5, wherein the third strip is a corrugated strip defining alternating third channels and third ridges that are at a third angle relative to the central axis along the spiral.

8. The arrester element of claim 1, wherein the first ridges abut the second ridges to form crossed and intersecting flow paths therebetween.

9. The arrester element of claim 1, wherein the first strip defines a first crimp height and the second strip defines a second crimp height, and
wherein each of the first crimp height and the second crimp height ranges, respectively, between about 0.5 millimeters and about 2.0 millimeters, inclusive.

10. The arrester element of claim 9, wherein the first crimp height is approximately equal to the second crimp height.

11. The arrester element of claim 1, wherein the first strip defines a first crimp width and the second strip defines a second crimp width, and
wherein each of the first crimp width and the second crimp width ranges, respectively between about 0.7 millimeters and about 3.0 millimeters, inclusive.

12. The arrester element of claim 11, wherein the first crimp width is approximately equal to the second crimp width.

13. A flame arrester configured to be disposed along a flow conduit to arrest a flame propagating along the flow conduit, the flame arrester including:
a housing that includes a cavity along a housing flow path and an opening for flow into the cavity, the housing being configured to be coupled to the flow conduit so that the cavity is in fluid communication with the flow conduit via the opening and fluid from the flow conduit flows through the housing along the housing flow path; and
an arrester element disposed within the cavity along the housing flow path, the arrester element including:
a cell element including a first strip and a second strip spirally wrapped around a central axis, wherein:
the first strip is a first corrugated strip defining a first corrugation pattern that defines first flow channels for flow of the fluid along the housing flow path, with the first flow channels extending at a first angle relative to the central axis, and
the second strip is a second corrugated strip defining a second corrugation pattern that defines second flow channels for flow of the fluid along the housing flow path, with the second flow channels extending at a second angle relative to the central axis.

14. The flame arrester of claim 13, wherein, the first strip abuts the second strip to form a plurality of crossed and intersecting flow paths with the first and second flow channels.

15. The flame arrester of claim 13, wherein the cell element further includes a third strip configured as flat strip that is spirally wrapped with the first and second strips so that:
the first strip contacts the third strip to form first flow paths between the first strip and the third strip, the first flow paths extending obliquely relative to the central axis; and
the second strip contacts an opposite side of the third strip from the first strip to form second flow paths between the second strip and the third strip, the second flow paths extending obliquely relative to the central axis; and
wherein the first and second flow paths include crossed and non-intersecting flow paths.

16. The flame arrester of claim 15, wherein the cell element further includes a fourth strip configured as flat strip that is spirally wrapped around the central axis with the first, second, and third strips so that:
the first strip contacts the fourth strip to form third flow paths between the first strip and the fourth strip, the third flow paths being parallel to the second flow paths; and
the second strip contacts the fourth strip to form fourth flow paths between the second strip and the fourth strip, the fourth flow paths being parallel to the first flow paths.

17. An arrester element for a flame arrester, the arrester element including:
a core defining a central axis; and
a cell element including a plurality layers, with each layer of the plurality of layers including at least a first strip and a second strip that are in contact with one another to define a non-linear flow path between the first and second strips, the non-linear flow path extending between an upstream side and a downstream side of the arrester element relative to a flame-quenching fluid flow across the arrester element.

18. The arrester element of claim 17, wherein the first strip is a corrugated strip having first corrugations at a first angle relative to the central axis and the second strip is a corrugated strip having second corrugations at a second angle relative the central axis, the second angle being different from the first angle.

19. The arrester element of claim 17, wherein the first strip defines a first crimp height and the second strip defines a second crimp height.

20. The arrester element of claim 17, wherein the first strip and the second strip are spirally wrapped around the core so that the non-linear flow path allows a fluid flow in a substantially axial direction, relative to the central axis, from the upstream side of the cell element to the downstream side of the cell element.
